(19) United States
(12) Patent Application Publication
(10) Pub. No.: US 2016/0147908 A1
(43) Pub. Date: May 26, 2016

(54) 3D MODEL COMPONENT COMPARING SYSTEM AND METHOD THEREOF

(71) Applicants: INVENTEC (PUDONG) TECHNOLOGY CORPORATION, Shanghai City (CN); INVENTEC CORPORATION, Taipei City (TW)

(72) Inventors: CHUNG-SHENG NI, Taipie City (TW); CHIH-PIN WEI, Taipei City (TW); CHANG-HSIN CHIU, Taipei City (TW); CHUN-YING YANG, Taipei City (TW)

(21) Appl. No.: 14/792,887

(22) Filed: Jul. 7, 2015

(30) Foreign Application Priority Data
Nov. 26, 2014 (CN) 201410696599.7

(51) Int. Cl. G06F 17/50

(52) U.S. Cl. CPC G06F 17/50

(57) ABSTRACT

A 3D model component comparing system and method thereof are provided. The 3D model component comparing system includes a capturing unit, a setting unit, a processing unit and a prompting unit. The capturing unit acquires a first model and a second model. The setting unit sets a 3D absolute coordinate into the first model and the second model. The processing unit compares a plurality of components between the first model and the second model in the 3D absolute coordinate and determines whether coordinate values of the plurality of components which have the same component names between the first model and the second model are not identical. The prompting unit outputs a prompting message if the coordinate values of the plurality of components, which have the same component names, between the first model and the second model are not identical. Thus design error rate is reduced.

### CROSS-REFERENCE TO RELATED APPLICATIONS

This non-provisional application claims priority under 35 U.S.C. §119(a) on Patent Application No. 201410696599.7 filed in China on Nov. 26, 2014, the entire contents of which are hereby incorporated by reference.

### BACKGROUND OF THE INVENTION

1. Technical Field of the Invention

The present invention relates to a system and a method for assisting model design, particularly to a 3D component comparing system and method thereof.

2. Description of the Related Art

With the advancement of the modern technology, various commercial products are brought to the market, and the structures of the products are getting more and more complex. Therefore, the time and costs of the product design become important keys in association with the success in the market.

Product design usually relies on the participation of various personnel of different areas, and the coordination between people is a big challenge during the design process. For example, if the designer does not grasp the detailed modifications between different versions during the design process, it can result in unnecessary mistakes and modifications, and the costs of product design are increased.

Additionally, a tiny modification of any component between different design versions may cost a lot of time and human resources for the comparison in advance when the complexity of the product structure increases, so that the design can be moved to the next stage. However, the comparison process usually lacks of a precise method and can only rely on the experiences of product designer and the observation of a naked eye.

### SUMMARY OF THE INVENTION

A 3D model component comparing system having a model design interface includes a capturing unit, a setting unit, a processing unit, and a prompting unit. The capturing unit is for capturing a first model and a second model in the model design interface and the first model has a plurality of components, and the second model has a plurality of components. The setting unit is coupled to the capturing unit and is for setting an identical 3D absolute coordinate into the first model and the second model respectively. The processing unit is coupled to the setting unit and is for comparing a plurality of components of the first model with a plurality of components of the second model in a 3D absolute coordinate to obtain at least one first component with the same name in the first model and at least one second component with the same name in the second model which have the same component name, and calculating a coordinate value of the at least one first component with the same name and a coordinate value of the at least one second component with the same name, and determining the coordinate value of the at least one first component with the same component and the coordinate value of the corresponding at least one second component with the same name, and sending a prompting signal when the coordinate value of the at least one first component with the same component is different from the coordinate value of the at least one second component with the same name. The prompting unit is coupled to the processing unit and is for receiving the prompting signal sent by the processing unit and outputting a prompting message indicating that the coordinate values of the plurality of components with the same names are different.

In an embodiment, the processing unit is for calculating a component number of the plurality of components with the same component names and with different coordinate values among the first model and the second model.

In an embodiment, the processing unit is for calculating a difference value between a total component number of the first model and the component number, and when the difference value is greater than a default value, the processing unit sends the prompting signal.

In an embodiment, the processing unit is for calculating a difference value between a total component number of the second model and the component number, and when the difference value is greater than a default value, the processing unit sends the prompting signal.

In an embodiment, the processing unit is for calculating a first difference value between the total component number of the first model and the component number and a second difference value between the total component number of the second model and the component number, and when the first difference value and the second difference value are both greater than a default value, the processing unit sends the prompting signal.

A 3D model component comparing method for a 3D model component comparing system includes capturing a first model and a second model in the model design interface, the first model having a plurality of components and the second model having a plurality of components, setting an identical 3D absolute coordinate into the first model and the second model respectively, comparing a plurality of components of the first model with a plurality of components of the second model in the 3D absolute coordinate to obtain at least one first component with the same name in the first model and at least one second component with the same name in the second model which have the same component name, calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name, and receiving the prompting signal and outputting a prompting message indicating that the coordinate values of the plurality of components with the same names are different.

In an embodiment, the step of calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name further includes calculating a component number of the plurality of components with the same component names and with different coordinate values among the first model and the second model.

In an embodiment, the step of calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name further includes calculating a difference value between a total component number of the second model and the component number, and when the difference value is greater than a default value, the prompting signal is sent.

In an embodiment, the step of calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name further includes calculating a difference value between a total component number of the second model and the component number, and when the difference value is greater than a default value, the prompting signal is sent.

In an embodiment, the step of calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name further includes calculating a first difference value between the total component number of the first model and the component number and a second difference value between the total component number of the second model and the component number, and when the first difference value and the second difference value are both greater than a default value, the prompting signal is sent.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a block diagram of the 3D model component comparing system according to an embodiment;

FIG. 2 is a diagram of a plurality of components of the first model and the second model displayed in the model design interface according to an embodiment; and

FIG. 3 is a flowchart of the 3D model component comparing method according to another embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

When a product designer wants to proceed to the next stage during the product design process, he has to figure out the commonality or difference between different design versions in order to ensure the correctness of the design. However, the product designer possibly makes mistakes during the product design process because of coordinate modifications of components with the same name in different design versions. Therefore, the solution is specifically explained hereinafter.

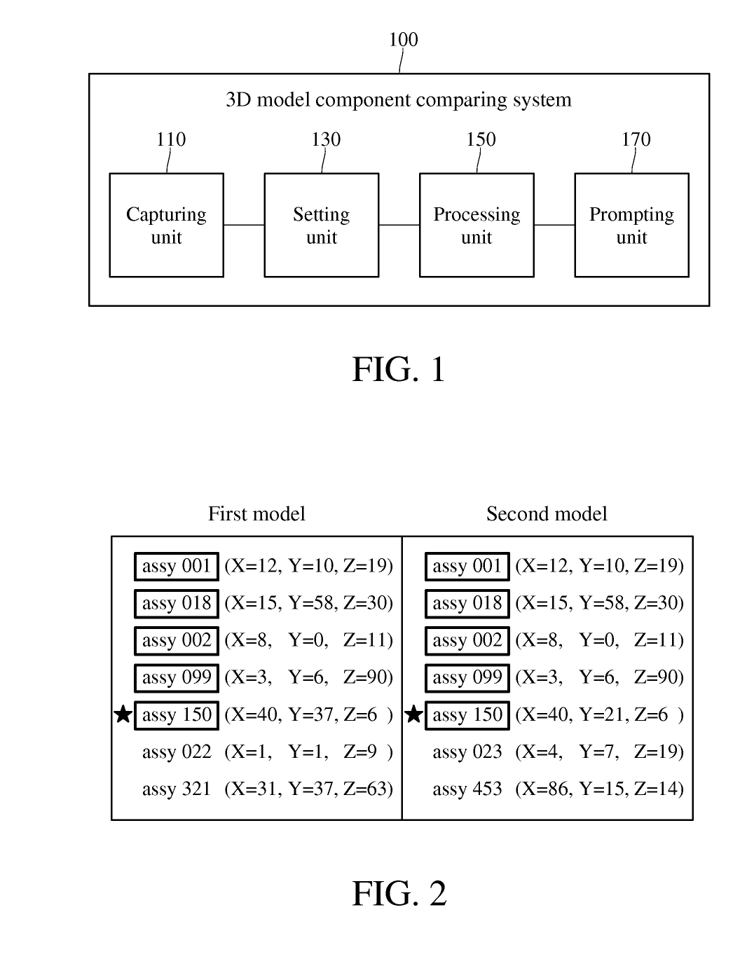

FIG. 1 is a block diagram of the 3D model component comparing system 100 according to an embodiment. FIG. 2 is a diagram of a plurality of components of the first model and the second model displayed in the model design interface according to an embodiment. As shown in FIG. 1, the device 100 includes a capturing unit 110, a setting unit 130, a processing unit 150, and a prompting unit 170. The setting unit 130 is coupled to the capturing unit 110, and the processing unit 150 is coupled to the setting unit 130, and the prompting unit 170 is coupled to the processing unit 150. In the present embodiment, the capturing unit 110, the setting unit 130, the processing unit 150, and the prompting unit 170 are but not limited to various micro processors or chips. Please refer to FIG. 1 and FIG. 2 together as follows.

First, the product designer captures the first model and the second model from the model design interface provided by the model-capturing unit 110. The first model and the second model have a plurality of components respectively. The first model and the second model are product models in different design versions during the product design process. For example, the first model is a prototype of the product provided by the upstream firms, and the second model is a modified product model after the downstream clients reviewed the prototype. In another example, the first model is a first-stage product model designed by the product designer A in the design team, and the second model is a second-stage product model designed by designer B based on the first-stage product model. The first model and the second model respectively have a plurality of components, and each of the plurality of components has a component name. The component name is the name named by the product designer.

Next, the setting unit 130 sets an identical 3D absolute coordinate into the first model and the second model respectively. In other words, the origins of the first model and the second model in the 3D absolute coordinate refer to an identical point. After inserting the identical 3D absolute coordinate into the first model and the second model, the plurality of components of the first model and the second model have their coordinates respectively.

After the first model and the second model are captured in the model design interface, the processing unit 150 continuously compares the plurality of components of the first model with the plurality of components of the second model in the 3D absolute coordinate to obtain at least one first component with the same name in the first model and at least one second component with the same name in the second model which have the same component names, and calculates the coordinate value of the at least one first component with the same name and the coordinate value of the at least one second component with the same name. As shown in FIG. 2, the captured first model includes the components assy001, assy018, assy012, assy099, assy150, assy022, and assy321, and the captured second model includes the components assy001, assy018, assy012, assy099, assy150, assy023, and assy453. The processing unit 150 calculates the coordinate values of the aforementioned components.

Additionally, the processing unit 150 further determines the coordinate value of the at least one first component with the same name and the coordinate value of the corresponding at least one second component with the same name. For example, the processing unit 150 calculates the component number of the plurality of components with the same name but with different coordinate values. When the coordinate value of the first component with the same name is different from the coordinate value of the corresponding second component with the same name, the processing unit 150 sends a prompting signal.

For example, the processing unit 150 determines that the component name of assy150 in the first model is identical to the component name of assy150 in the second model, but the coordinate value of assy150 in the first model is different from the coordinate value of assy150 in the second model. As shown in FIG. 2, the coordinate value of assy150 in the first model is X=40, Y=37, Z=6, and the coordinate value of assy150 in the second model is X=40, Y=21, Z=6. Therefore, the processing unit 150 determines that the component number of the plurality of components with the same name but with different coordinate values is 1. Additionally, when the coordinate value of the first component with the same name is different from the coordinate value of the second component with the same name, the processing unit 150 sends the prompting signal.

In another embodiment, the processing unit 150 also calculates the difference value between the aforementioned component number and the total component number of the first model, and when the difference value is greater than a default value, the processing unit 150 sends the prompting signal. In a further embodiment, the processing unit 150 also calculates a difference value between the aforementioned component number and the total component number of the second model, and when the difference value is greater than a default value, the processing unit 150 sends the prompting signal. In an additional embodiment, the processing unit 150 also calculates a first difference value between the aforementioned component number and the total component number of the first model and a second difference value between the aforementioned component number and the total component number of the second model and when the first difference value and the second difference value are both greater than a default value, the processing unit 150 sends the prompting signal.

Next, the prompting unit 170 receives the prompting signal sent by the processing unit 150 and outputs a plurality of prompting messages, which indicate that the coordinate values of the components with the same name are different.

For example, as shown in FIG. 2, the method of outputting the prompting message by the prompting unit 170 is marking the first component with the same name but with a different coordinate value assy150 and the second component with the same name but with a different coordinate value assy150 with stars in the component list of the first model and the component list of the second model in the model design interface. In another embodiment, the method of outputting the prompting message by the prompting unit 170 is listing the first components with the same names but with different coordinate values and the second components with the same names but with different coordinate values one by one in an extra independent list. In a further embodiment, the method of outputting the prompting message by the prompting unit 170 is respectively marking the first components with the same names but with different coordinate values and the second components with the same names but with different coordinate values in the blueprint of the first model and the second model in the model design interface. Therefore, the prompting unit 170 outputs the prompting message with various methods and the aforementioned embodiments are for illustrating but not for limiting the present invention.

In another embodiment, when the processing unit 150 determines that the ratio of the component number of the plurality of components with the same name but with different coordinate values to the total component number of the first model or the second model is greater than a default ratio value among the first model and the second model, the prompting unit 170 sends a warning message.

For example, after the processing unit 150 finishes the comparisons, when the component number of the plurality of components with the same name but with different coordinate values is greater than 98% of the total component number, the result is possibly caused by a shift of the whole model instead of partial modifications of the product design. Therefore, the warning message is sent to notify the product designer to calibrate the position of the whole model.

In another example, during the comparison process of the processing unit 150, when the component number of the plurality of components with the same name but with different coordinate values is greater than 30% of the total component number, the processing unit 150 sends a warning message without finishing the comparisons of all components.

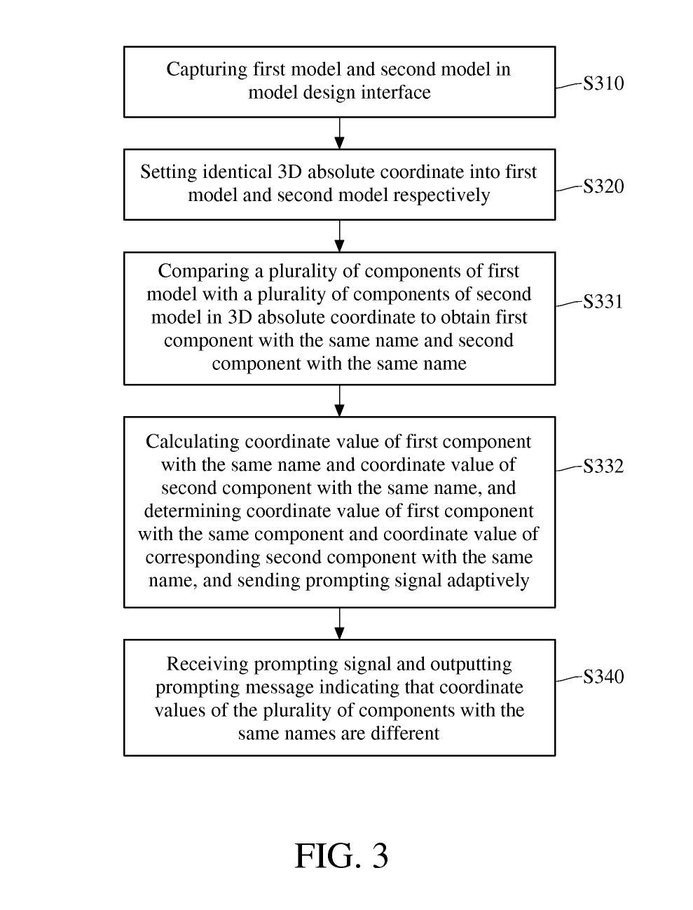

FIG. 3 is a flowchart of the 3D model component comparing method according to another embodiment. As shown in FIG. 3, the 3D model component comparing method includes the steps S310, S320, S331˜S332, and S340. Please refer to FIG. 1, FIG. 2, and FIG. 3.

As the aforementioned explanation, in the step S310, the product designer captures the first model and the second model in the model design interface provided by the capturing unit 110, and the first model includes a plurality of components and the second model includes a plurality of components. In the step S320, the setting unit 130 sets an identical 3D absolute coordinate into the first model and the second model respectively. In the step S331, the processing unit 150 compares a plurality of components of the first model with a plurality of components of the second model in a 3D absolute coordinate to obtain at least one first component with the same name in the first model and at least one second component with the same name in the second model which have the same component name. In the step S332, the processing unit 150 calculates a coordinate value of the at least one first component with the same name and a coordinate value of the at least one second component with the same name, and determines the coordinate value of the at least one first component with the same component and the coordinate value of the corresponding at least one second component with the same name to send a prompting signal adaptively. In the step S340, the prompting unit 170 receives the prompting signal and outputs a plurality of prompting messages indicating that the coordinate values of the components with the same name are different. The details of the aforementioned steps are specifically described above and are not further explained hereinafter.

In an embodiment, the capturing unit captures the first model and the second model in the model design interface, and the setting unit sets an identical 3D absolute coordinate into the first model and the second model respectively, and the processing unit likewise compares a plurality of components of the first model with a plurality of components of the second model in a 3D absolute coordinate to obtain at least one first component with the same name in the first model and at least one second component with the same name in the second model, and calculating the coordinate values. The comparison process determines whether the coordinate values of the first components with the same component are identical to the coordinate values of the corresponding second components with the same name. If no, the processing unit calculates the component number of the components with the same names but with different coordinate values among the first components with the same names and the second components with the same names. The processing unit determines whether to send the prompting signal to the prompting unit to send prompting message according to the relationship between the component number and the total component number. Additionally, when the ratio of the component number of the components with the same names but with different coordinate values is greater than a default ratio value, the warning message is also outputted. Therefore, mastery of modifying the internal components resulting from the modified design version to the product designer is enhanced and the design error rate by multiple designers is reduced, so that unnecessary design mistakes and modifications are avoided and the design costs are further reduced.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A 3D model component comparing system having a model design interface, the 3D model component comparing system comprising:
a capturing unit for capturing a first model and a second model in the model design interface, the first model having a plurality of components and the second model having a plurality of components;
a setting unit coupled to the capturing unit, for setting an identical 3D absolute coordinate into the first model and the second model respectively;
a processing unit coupled to the setting unit, for comparing the plurality of components of the first model with the plurality of components of the second model in the 3D absolute coordinate to obtain at least one first component with the same name in the first model and at least one second component with the same name in the second model which have the same component name, and calculating a coordinate value of the at least one first component with the same name and a coordinate value of the at least one second component with the same name, and determining the coordinate value of the at least one first component with the same component and the coordinate value of the corresponding at least one second component with the same name, and sending a prompting signal when the coordinate value of the at least one first component with the same component is different from the coordinate value of the at least one second component with the same name; and
a prompting unit coupled to the processing unit, for receiving the prompting signal sent by the processing unit and outputting a prompting message indicating that the coordinate values of the plurality of components with the same names are different.

2. The 3D model component comparing system of claim 1, wherein the processing unit is for calculating a component number of the plurality of components with the same component names and with different coordinate values among the first model and the second model.

3. The 3D model component comparing system of claim 2, wherein the processing unit is for calculating a difference value between a total component number of the first model and the component number, and when the difference value is greater than a default value, the processing unit sends the prompting signal.

4. The 3D model component comparing system of claim 2, wherein the processing unit is for calculating a difference value between a total component number of the second model and the component number, and when the difference value is greater than a default value, the processing unit sends the prompting signal.

5. The 3D model component comparing system of claim 2, wherein the processing unit is for calculating a first difference value between the total component number of the first model and the component number and a second difference value between the total component number of the second model and the component number, and when the first difference value and the second difference value are both greater than a default value, the processing unit sends the prompting signal.

6. A 3D model component comparing method for a 3D model component comparing system, the 3D model component comparing system having a model design interface, the 3D model component comparing method comprising:
capturing a first model and a second model in the model design interface, the first model having a plurality of components and the second model having a plurality of components;
setting an identical 3D absolute coordinate into the first model and the second model respectively;
comparing the plurality of components of the first model with the plurality of components of the second model in the 3D absolute coordinate to obtain at least one first component with the same name in the first model and at least one second component with the same name in the second model which have the same component name;
calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name; and
receiving the prompting signal and outputting a prompting message indicating that the coordinate values of the plurality of components with the same names are different.

7. The 3D model component comparing method of claim 6, wherein the step of calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name further comprises:
calculating a component number of the plurality of components with the same component names and with different coordinate values among the first model and the second model.

8. The 3D model component comparing method of claim 7, wherein the step of calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name further comprises:
calculating a difference value between a total component number of the second model and the component number, and when the difference value is greater than a default value, the prompting signal is sent.

9. The 3D model component comparing method of claim 7, wherein the step of calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name further comprises:
calculating a difference value between a total component number of the second model and the component number, and when the difference value is greater than a default value, the prompting signal is sent.

10. The 3D model component comparing method of claim 7, wherein the step of calculating a coordinate value of the at least one first component with the same name and a coordinate value of the at least one second component with the same name, and determining the coordinate value of at least one first component with the same component and the coordinate value of the corresponding at least one second component with the same name, and sending a prompting signal when the coordinate value of the at least one first component with the same component is different from the coordinate value of the at least one second component with the same name further comprises:
calculating a first difference value between the total component number of the first model and the component number and a second difference value between the total component number of the second model and the component number, and when the first difference value and the second difference value are both greater than a default value, the prompting signal is sent.
